(19) United States
(12) Patent Application Publication
(10) Pub. No.: US 2002/0188805 A1
(43) Pub. Date: Dec. 12, 2002

(54) Mechanism for implementing cache line fills

(76) Inventor: Sailesh Kottapalli, Milpitas, CA (US)

Correspondence Address: Leo V. Novakoski, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/875,673

(22) Filed: Jun. 5, 2001

(51) Int. Cl. G06F 13/00

(52) U.S. Cl. 711/119; 711/122

(57) ABSTRACT

The present invention provides a mechanism for implementing cache line fills. In response to a target address, a decoder generates primary and secondary look-ups to a first cache on standard and pseudo ports, respectively. Responsive to miss by the primary access, a data block is returned to the first cache, the data block having a size determined by a hit/miss signal generated by the secondary look-up.

### BACKGROUND OF THE INVENTION

1. Technical Field

The present invention relates to computer systems and, in particular to mechanisms for fetching data for processors that execute multiple threads concurrently.

2. Background Art

Modem high-performance processors are designed to execute multiple instructions on each clock cycle. To this end, they typically include extensive execution resources to facilitate parallel processing of the instructions. The efficient use of these resources may be limited by the availability of instructions that can be executed in parallel, which is referred to as instruction level parallelism (ILP). Instruction dependencies limit the ILP available in a single execution thread. Multi-threaded processors address this limitation by allowing instructions from two or more instructions threads to execute concurrently.

It is the function of the memory system to keep the processor's execution resources supplied with data and instructions for the executing threads. The memory system typically includes a hierarchy of caches, e.g. L1, L2, L3 . . . , and a main memory. The storage capacities of the caches generally increase from L1 to L2, et seq., as does the time required by succeeding caches in the hierarchy to return the data or instructions to the processor. The response times depend, in part, on the cache sizes. Lower level caches, e.g. caches closer to the processor's execution cores, are typically smaller than higher-level caches. For example, an L1 instruction cache may have a line size that is half the size of an L2 instruction cache. Here, a “line” refers to an instruction block stored by the cache at each of its entries.

A request that misses in a first cache triggers a request to a second cache in the hierarchy. If the request hits in the second cache, it returns an instruction block that includes the requested cache line to the first cache. Because the caches typically implement different line sizes, an appropriate size must be selected for the instruction block returned by the second cache. In the above example, the request to the L2 cache may return half an L2 cache line to the L1 cache. This approach is not very efficient because instructions are typically executed sequentially, and the instructions stored in other half of the L2 cache line will likely be targeted by a subsequent access to the L1 cache. If these instructions are not already in the L1 cache, they will generate another L1 cache miss and another cache line fill transaction between L1 and L2.

A more efficient approach for the example system is to transfer both halves of the L2 cache line—the portion corresponding to the L1 cache entry targeted by the original access (the “primary block”) and the portion corresponding to the adjacent L1 cache entry (the “secondary block”). The processor first determines that the secondary block of the L2 cache line is not already in the L1 cache, since the presence of the same instruction block in multiple entries can undermine the cache's integrity.

For a single threaded processor, testing the L1 instruction cache for the presence of the secondary block is relatively simple, because this cache is idle during the L2 request. This allows the L1 cache to process a “pseudo request” while the L2 cache processes a request for a full L2 cache line, e.g. primary and secondary blocks. The pseudo request targets the L1 cache line in which the secondary block would be stored if present in the L1 cache. It is termed “pseudo” because it does not alter the replacement state, e.g. LRU bits, of the targeted line nor does it return data if it hits in the L1 cache. It merely tests the L1 cache for the presence of the secondary block. If the pseudo request misses in the L1 cache, the full L2 cache line is returned to the L1 cache. If the pseudo request hits in the L1 cache, the secondary block of the full L2 cache line is dropped from the data return.

For multi-threaded processors, a second thread may access an L1 instruction cache if a request from a first thread misses in this cache. That is, an L1 cache miss in a multi-threaded processor does not guarantee that idle cycles will be available to process a pseudo request to the L1 cache. The pseudo request may be handled by delaying the L1 cache access of the other thread, or the L2 cache access may only return the primary block of the L2 cache line. Another alternative is to make the L1 cache multi-ported, which allows it to service multiple requests concurrently. Multiple ports consume valuable area on the processor die, since ports must be added to the tag array, the data array and the translation lookaside buffer (TLB) of the cache, and multiple decoders must be provided to generate look-up indices for each port on the tag array. The resulting increases in die area are significant, and they are avoided if possible.

The present invention addresses these and other issues associated with transferring instruction blocks between caches having different cache line sizes.

### BRIEF DESCRIPTION OF THE DRAWINGS

The present invention may be understood with reference to the following drawings, in which like elements are indicated by like numbers. These drawings are provided to illustrate selected embodiments of the present invention and are not intended to limit the scope of the invention.

FIG. 1 is a block diagram of a computer system that includes a hierarchy of cache memory structures.

FIG. 2 is a block diagram representing the transfer of cache lines between an L1 cache and an L2 cache in which the cache line size of the L2 cache is twice that of the L1 cache.

FIG. 3 is a block diagram representing one embodiment of an apparatus for implementing cache line fills in accordance with the present invention.

FIG. 4 is a flowchart representing one embodiment of a method in accordance with the present invention for implementing cache line fills.

FIG. 5 is a flowchart representing another embodiment of a method for implementing cache line fills in accordance with the present invention.

### DETAILED DESCRIPTION OF THE INVENTION

The following discussion sets forth numerous specific details to provide a thorough understanding of the invention. However, those of ordinary skill in the art, having the benefit of this disclosure, will appreciate that the invention may be practiced without these specific details. In addition, various well-known methods, procedures, components, and circuits have not been described in detail in order to focus attention on the features of the present invention.

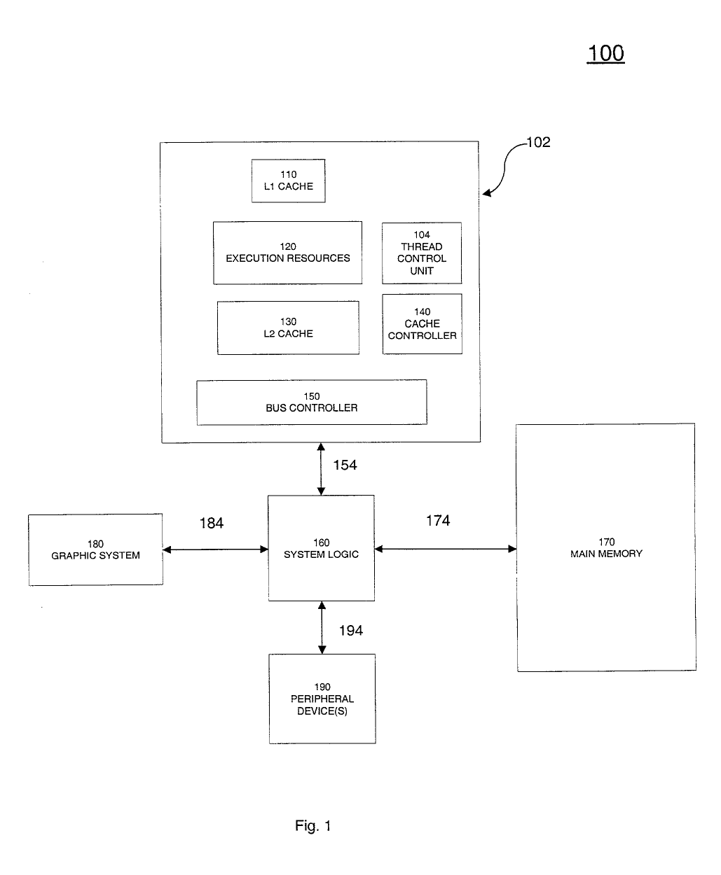

FIG. 1 is a block diagram representing one embodiment of a computer system 100 in which the present invention may be implemented. Computer system 100 includes a processor 102 and main memory 170, which communicate through a chipset or system logic 160. A graphics system 180 and peripheral device(s) 190 are also shown communicating through system logic 160.

Processor 102 includes an L1 cache 110, which provides instructions to execution resources 120. If the instructions are not available in L1 cache 110, a request is sent to an L2 cache 130. Misses in L2 cache 130 may be serviced by a higher-level cache (not shown) or main memory 170. A cache controller 140 manages requests to the various levels of the cache hierarchy and a bus controller 150 manages requests that are sent to main memory 170 or to a higher-level off-chip cache (not shown).

Also shown in processor 102 is a thread control unit 104. Thread control unit 104 manages multiple execution threads as they execute on processor 102. For example, thread control unit 104 may schedule instructions from different threads, update architectural state information for the different threads, and allocate shared resources between the different threads. By handling instructions from multiple execution threads concurrently, multi-threaded processor 102 increases the probability that execution resources 120 are used efficiently.

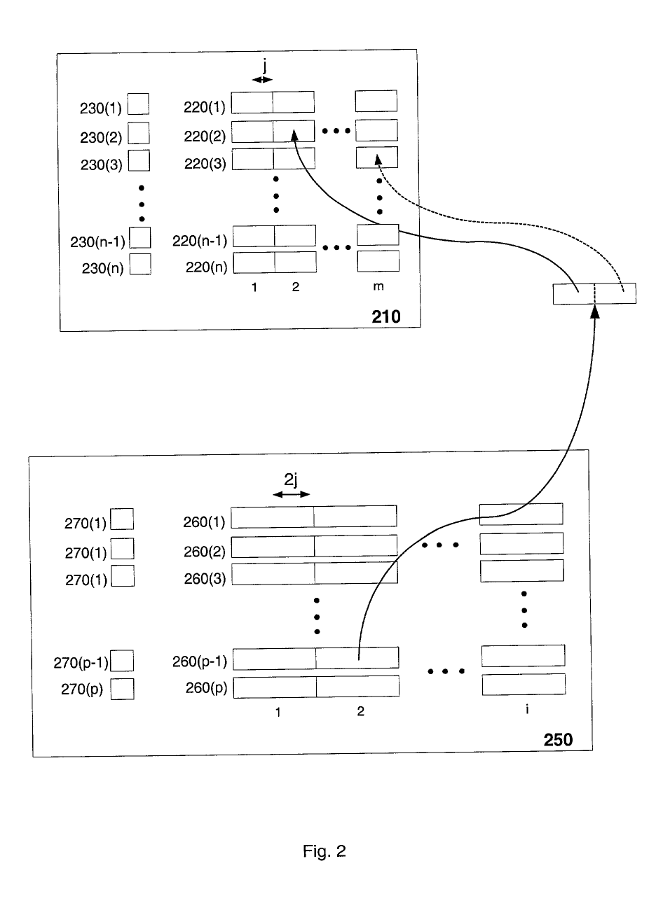

FIG. 2 is a block diagram representing embodiments of a first cache 210, e.g. cache 110, and a second cache 250, e.g. cache 130, suitable for use with the present invention. The disclosed embodiment of cache 210 includes n sets 220(1)-220(n) of m-ways each, i.e. cache 210 is a m-way set associative cache. An instruction request specifies a target address, a portion of which (set bits) selects one of sets 220(1)-220(n) (generically, set 220). Another portion of the target address (the tag bits) is compared with values associated with the m-ways of the selected set. If the tag bits match, the value associated with one of the ways, the instruction block is present in a data portion of a cache entry identified by the set/way combination. For the disclosed embodiment of cache 210, the data portion of an entry is j-bits wide.

In an m-way set associative cache, the tag bits of a target address may be stored in any of the m-ways of a given set. For the disclosed embodiment of cache 210, LRU bits 230(1)-230(n) are used to indicate which of the m-ways for a given set 220 should be assigned to store a new instruction block transferred to cache 210, e.g. the cache replacement policy. Similarly, the disclosed embodiment of cache 250 includes p sets 260(1)-260(p) of i-ways each and corresponding LRU bits 270(1)-270(p). For the disclosed embodiment of cache 250, the data portion of each entry is 2j-bytes long.

Caches 210 and 250 are shown as m and i-way set associative caches to indicate that the present invention applies to systems that implement any degree of associativity, including those in which the first and second caches have different degrees of associativity. In addition, caches 210, 250 are illustrated as employing an LRU replacement algorithm, but the present invention does not depend on the use of a particular replacement algorithm.

A request to second cache 250 is triggered in response to an access that misses in first cache 210. If the request hits in second cache 250, a data block of j bytes (primary data block) or 2j-bytes (primary and secondary data blocks) is provided to first cache 210, depending on whether or not the secondary data block is already in L1 cache 210. As discussed below in greater detail, an embodiment of cache 210 performs a pair of tag look-ups, in response to a cache access to a target address. The first tag look-up targets a set to which the target address maps (“primary look-up”) and the second tag look-up targets an adjacent set (“secondary look-up”). Results of the second tag look-up may be used to determine whether a full or a partial cache line is returned by L2 cache 250 responsive to a miss in cache 210 at the target address. For example, an access targeting an instruction block that maps to entry 220(2) of first cache 210 triggers a primary look-up at entry 220(2) and a secondary look-up at entry 220(3). If the primary look-up misses, a request to second cache 250 returns a full cache line or a partial cache line according to whether the secondary look-up misses or hits.

For one embodiment of the invention, the second tag look-up records whether a look-up at the adjacent set hits in cache 210. The secondary look-up does not return an instruction block or adjust the LRU bits. In this regard, it is similar to the pseudo request described above. However, because the secondary look-up is generated concurrently with the primary look-up, it does not require additional cycles on cache 210 or delay access to cache 210 by a different execution thread.

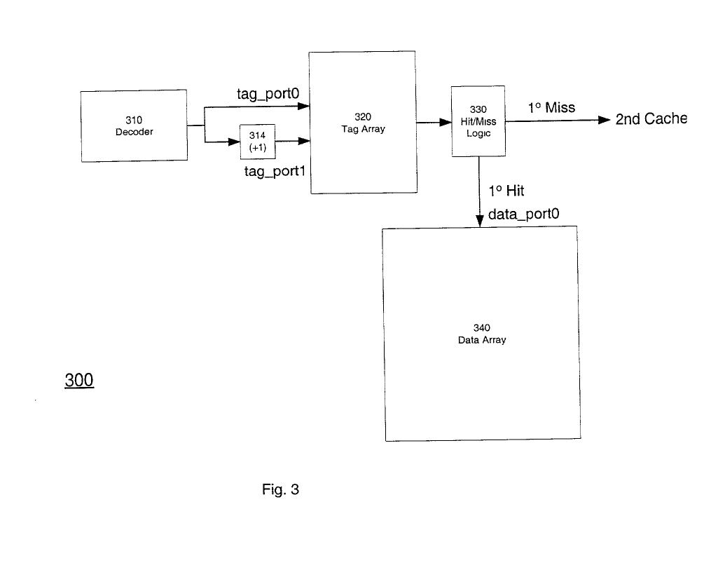

FIG. 3 is a block diagram of one embodiment of a first cache 300 in accordance with the present invention. Cache 300 includes a decoder 310, a tag array 320, a hit/miss module 330 and a data array 340. Other components, such as a TLB, are not shown. Decoder 310 receives a target address (or portion thereof) specified by an access request to first cache 300, and it generates first and second look-up requests to tag array 320 in response to the target address.

For the disclosed embodiment of decoder 310, a target address that maps to a first set, triggers look-up requests to the first set and to an adjacent set. For example, the first look-up request may specify the n^{th} set through a corresponding set index. A set index incrementer 314 generates the second look-up request to the (n+1)^{st}. Tag array 320 compares the tag bits of the targeted address with tag bits stored at each way of its n^{th} and (n+1)^{st} sets, respectively, and generates hit and miss signals for the pair of look-ups.

For the disclosed embodiment of cache 300, first and second look-up requests are provided to tag array 320 through tag_port0 and tag_port1, respectively. An instruction block corresponding to look-up that hits on tag_port0 is accessed through data_port0. That is tag_port0 and data_port0 form a standard port that is driven by decoder 310 to process a standard look-up operation (A TLB and its associated port are not shown). Since the secondary look-up does not return data, a data port corresponding to tag_port1 is unnecessary, and tag_port1 thus forms a “pseudo-port”. Further, tag_port1 does not require its own decoder, since the set it targets may be driven by a modified output of decoder 310, as indicated in the figure. Thus, the die used to implement and support the pseudo port of cache 300 (tag_port1) is substantially less than the die area used to implement and support an additional standard port (tag_port, data_port, decoder).

Hit/miss module 330 generates signals to data array 340 of the cache and to a second cache (not shown) in the hierarchy, as needed, responsive to the hit/miss status of the primary and secondary look-ups to tag array 320. For example, if the primary look-up hits in tag array 320, the corresponding instruction block (cache line) is retrieved from data array 320 and the hit/miss signal of the secondary look-up is ignored. If the primary look-up misses in tag array 320, a request is forwarded to the second cache. Assuming the forwarded request hits, the size of the instruction block returned from the second cache depends on whether the secondary look-up hit or missed in the first cache. If the secondary look-up missed in tag array 320, the request returns a full line from the second cache. If the second look-up hits in tag array 320, the request returns a partial line of the second cache. For one embodiment of the invention, a full cache line may be retrieved from the second cache, and a portion of the retrieved cache line may be retained or dropped according to the hit/miss signal generated by the secondary look-up.

For an embodiment of the invention in which the first cache has a 32-byte line size and the second cache has a 64-byte line size, misses by the primary and secondary look-ups trigger return of a 64 byte line from the second cache. Where the primary look-up misses and the secondary look-up hits in first cache 300, the request to the next cache returns a 32-byte line, beginning at the byte to which the target address maps.

Table 1 summarizes the actions indicated by one embodiment of hit/miss module 330, responsive to hit/miss signals associated with primary and second look-ups. For the disclosed table, data is returned from data array 340 of the first cache if the primary look-up hits in tag array 320, independent of the hit/miss signal generated by the secondary look-up. If the primary look-up misses in tag array 320, the request to the next cache returns a full cache line if the secondary look-up also misses, and it returns a partial, i.e. half, cache line if the secondary look-up hits the first cache.

TABLE 1

| | Primary Hit | Primary Miss |
|---|---|---|
| Secondary Hit | No request is sent to the second | Request to second cache returns only |
| | cache. The primary access is | the portion of cache line |
| | satisfied from the first cache. | corresponding to primary access |
| Secondary Miss | No request is sent to the second | Request to the second cache returns |
| | cache. The primary access is | portions of the second cache line |
| | satisfied from the first cache. | that correspond to the primary and |
| | | secondary accesses |

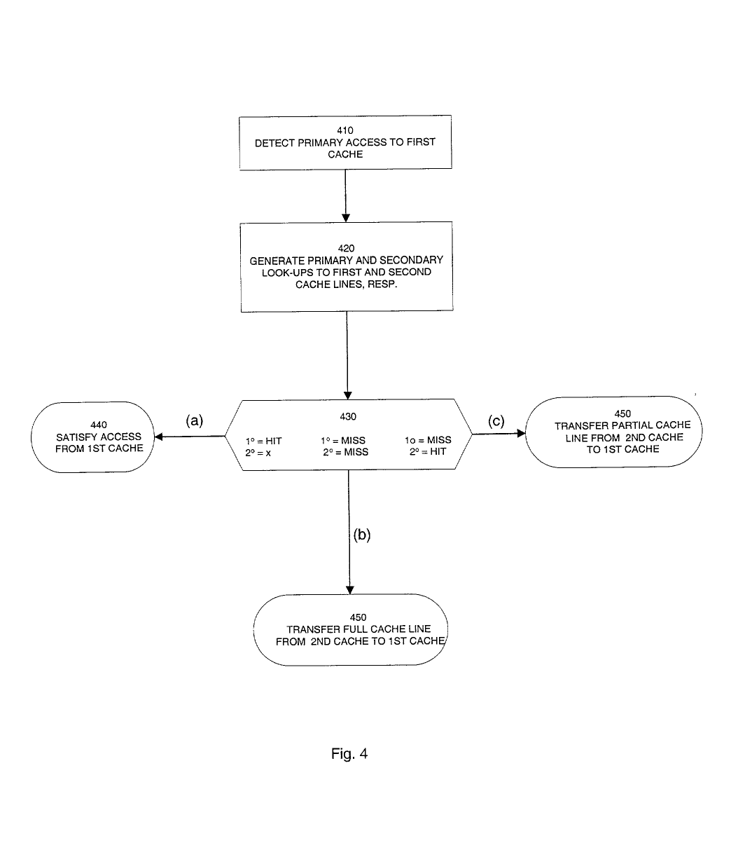

FIG. 4 is a flowchart providing an overview of one embodiment of a method 400 for implementing cache line fills in accordance with the present invention. Method 400 is initiated in response to detecting 410 an access targeting a first address (primary access). Responsive to the detected access, primary and secondary look-ups are generated 420 to a cache line associated with the first address (“first cache line”) and to a second cache line, respectively. If the first look-up hits 430(a) in the first cache, the access is satisfied 440 using data from the first cache line, regardless of the hit/miss status of the second look-up (2°=x or “don't care”). If the first and second look-ups miss 430(b) in the first cache, a full cache line is returned 450 from a next cache in the memory hierarchy (“second cache”). If the first look-up misses and the second look-up hits in the first cache 430(c), a portion of a cache line corresponding to the first address is returned 460 from the second cache.

In the foregoing discussion, it has been assumed that the primary and secondary accesses map to the first and second halves, respectively, of the cache line in the second cache (for the case in which the second cache has a cache line size twice that of the first cache). Under these circumstances, primary and secondary look-ups that miss in the first cache can be satisfied by a single cache line from the second cache. If the primary access maps to the second half of the cache line of the second cache, the benefits of implementing a concurrent secondary look-up may be eliminated. This is illustrated below for a first cache having a 32 byte cache line size and a second cache having a 64 byte cache line size.

For one embodiment of decoder 310, the secondary look-up is generated from the primary look-up by forcing a bit of the primary look-up index to a first logic state. If this bit is already in the first logic state, there is no difference between the primary and secondary look-up indices. For example, in a 32-byte cache line, bits [4:0] of the target address provide an offset to the targeted byte in the cache line, and the next bit (bit 5) distinguishes between adjacent cache lines. For a 64 byte cache line, bits [5:0] of the target address indicate the offset to the targeted byte, which appears in the first or second half of the cache line according to the state of bit 5. For this embodiment, if bit 5 is zero, the index maps to a byte in the first half of 64 byte cache line. This byte is included in an access that returns the first 32 bytes of the cache line, i.e. an access that maps to the cache line boundary of the second cache. If bit 5 is one, the index maps to the second half of the 64 byte cache line, and it is included in an access that returns the second 32 bytes of cache line. This access does not map to the second cache line boundary.

One embodiment of decoder 310 generates the secondary look-up index by forcing bit 5 of the target address to one. If this bit is already one for the primary look-up index, there is no difference between the primary and secondary look-up indices, and both map to the second half of the corresponding 64 byte cache line of the second cache. There is no reason to return the full 64-byte cache line in this case (assuming sequential instructions are stored in increasing memory addresses). If bit 5 of the target address is zero, the primary look-up index maps to the first half of the 64 byte cache line and the secondary look-up maps to the second half of the 64 byte cache line. In this case, returning the full 64 byte cache line from the second cache on primary and secondary look-up misses in the first cache is justified. Similar arguments apply to different cache line sizes.

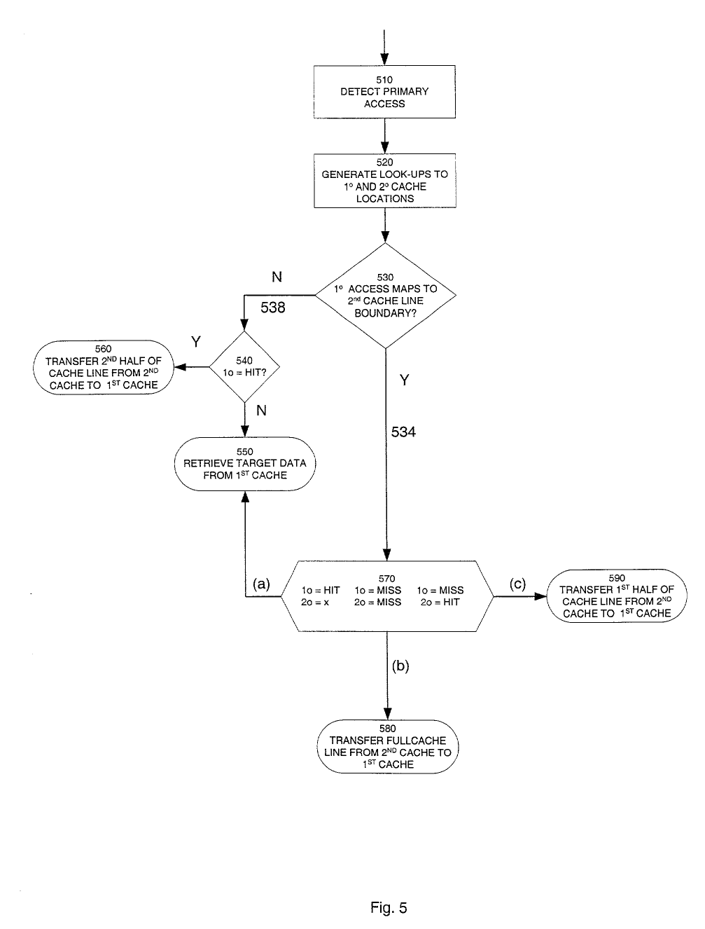

FIG. 5 is a flowchart representing in greater detail another embodiment of a method for implementing cache line fills in accordance with the present invention. The disclosed embodiment of method 500 is initiated in response to detecting 510 an access to the first cache (“primary access”). The access may be a request specifying a target address (or a portion thereof) for an instruction block or cache line. Look-ups are generated 520 to a first cache line associated with the target address (“primary look-up”) and to second cache line that is adjacent to the first cache line (“secondary look-up”), responsive to the primary access.

If the primary access targets a memory address that maps to a cache line boundary of the second cache 530, the primary access may return a full cache line from the second cache in the event it misses in the first cache. In this case, method 500 proceeds down path 534. If the primary access targets a memory address that does not map to a cache line boundary of the second cache 530, the second cache may only return a portion of a cache line to the first cache, in the event it misses in the first cache. In this case, method 500 proceeds down path 538.

For path 534, if the primary access hits in the first cache 570(a), the first cache provides 550 the targeted data. If the primary and secondary look-ups to the first cache miss 570(b), a full cache line from the second cache is returned 580 to the first cache. If the primary look-up misses and the secondary look-up hits, the first half of the cache line from the second cache is returned 590 to the first cache.

For path 538, if the primary access hits 540 in the first cache, the first cache provides 550 the targeted data. If the primary access misses 540 in the first cache, the second half of the cache line from the second cache is returned 590 to the first cache.

For convenience, method 500 shows the target address (or portion thereof) of the primary access compared to the cache line boundary of the second cache (530) following generation of the primary and secondary look-ups. In the example described above, the comparison may be implemented by testing bit 5 of the target address (or its corresponding set index). The comparison may occur before, after or concurrently with generation of the look-ups, which may obviate the need for generating a secondary look-up if return of a full cache line from the second cache is precluded. Other variations of method 500 are also possible. For example, operations 540 and 560 may be dropped, and the three state determination indicated by 570 may simply collapse to a two state determination (primary look-up hit/miss) if return of a full cache line is precluded. Persons skilled in the art will recognize other variations on method 500 that are consistent with the present invention.

There has thus been disclosed a mechanism that implements cache line fills efficiently. The mechanism generates two or more look-ups, responsive to a primary access to a first cache. The additional look-ups, i.e. any look-ups generated in addition to the primary look-up, may be handled through pseudo-ports driven by an appropriately modified decoder. In the event the primary access misses in the first cache, the size of a block of data returned to the first cache from a second cache is determined according to the hit/miss signals generated by the two or more look-ups. The mechanism has been illustrated for the case in which the second cache has a cache line size (data block) twice as large as that of the first cache, but it is not limited to this particular configuration. In general, where the second cache has a data block size that is n times the data block size of the first cache, 1° through n° look-ups may be generated in the first cache, responsive to the 1° access, and appropriate sub blocks of the second cache may be returned to the fist cache, responsive to hit/miss signals generated by the 1° through n° look-ups.

The disclosed embodiments have been provided to illustrate various features of the present invention. Persons skilled in the art and having the benefit of this disclosure will recognize variations and modifications of the disclosed embodiments. For example, embodiments of the present invention are illustrated using instruction caches, because accesses to these caches tend to proceed sequentially. However, the present invention may also provide performance gains for data cache hierarchies. Systems that implement significant SIMD or vector operations, where data is accessed from sequential cache lines, may benefit from use of the disclosed cache line replacement mechanism in their data cache hierarchies. Further, the present invention may be used in systems whether they implement separate data and instruction caches or unified data/instruction caches.

The present invention may also provide benefits for uni-threaded processors that implement prefetching or other mechanisms that can access the first cache when the executing thread misses. For these processors, the instruction cache is not necessarily idle following a miss by the execution thread. The present invention, which triggers concurrent primary and secondary look-ups, responsive to an instruction fetch address, allows prefetches to proceed undelayed, even when the instruction fetch misses in the cache. The present invention may even provide benefits to processors that implement multi-ported caches, where the use of pseudo-ports to implement secondary look-ups frees up standard ports for other cache accesses.

The present invention encompasses these and other variations on the disclosed embodiments, which none the less fall within the spirit and scope of the appended claims.

I claim:

1. An apparatus comprising:
a tag array to store address information for data blocks;
a data array to store data blocks;
a decoder to access first and second entries of the tag array responsive to a request; and
hit/miss logic to process the request, responsive to hit/miss signals triggered by the access to the first and second entries.

2. The apparatus of claim 1, wherein the data blocks are instruction blocks, the request specifies a target address for an instruction block, and the first and second entries correspond to an entry to which a portion of the target address maps and an adjacent entry, respectively.

3. The apparatus of claim 2, wherein the hit/miss logic triggers a request to a higher-level cache if the access to the first entry of the tag array misses.

4. The apparatus of claim 2, wherein the hit/miss logic signals the higher-level cache to return a full cache line if the accesses to the first and second entries both miss.

5. The system of claim 4, wherein the hit/miss logic signals the higher-level cache to return a partial cache line if the access to the first entry misses and the access to the second entry hits.

6. The system of claim 1, wherein the tag array includes first and second tag ports to process the first and second accesses.

7. The system of claim 6, wherein the data array includes a first data port to process a first access that hits in the tag array, the first tag and data arrays forming a standard port.

8. The system of claim 7, wherein the decoder drives a first index to the first tag port and drives a modified version of the first index to the second tag port.

9. A method comprising:
detecting a target address;
generating first and second look-ups to a cache responsive to the target address; and
retrieving a data block from a second cache responsive to hit/miss signals generated by the first and second look-ups.

10. The method of claim 9, wherein generating comprises:
determining a first index from a first portion of the target address;
determining a second index from the first index; and
generating the first and second look-ups to entries indicated by the first and second indices, respectively.

11. The method of claim 9, wherein retrieving comprises retrieving a data block from the second cache responsive to the first look-up missing in the first cache.

12. The method of claim 11, wherein retrieving a data block comprises:
retrieving a data block having a first size responsive to the second look-up hitting in the first cache; and
retrieving a data block having a second size responsive to the second look-up missing in the first cache.

13. The method of claim 9, wherein generating first and second look-ups comprises:
generating a standard look-up to a first set determined from a portion of the target address; and
generating a pseudo-look-up to second set adjacent to the first set.

14. A device comprising:
a first cache including a plurality of entries, each entry to store an instruction block having a first size;
a decoder to generate multiple look-ups to the first cache responsive to a target address;
a second cache including a plurality of entries, each entry to store an instruction block having a second size that is greater than the first size; and
a request manager to transfer to the first cache an instruction block from the second cache having one of a plurality of sizes, responsive to results of the primary and secondary look-ups.

15. The device of claim 14, wherein the multiple look-ups are primary and secondary look-ups and the request manager transfers an instruction block having the second size responsive to the primary and secondary look-ups missing in the first cache.

16. The device of claim 14, wherein the multiple look-ups are primary and secondary look-ups and the decoder generates first and second set indices for the primary and secondary look-ups, respectively, responsive to set bits of the target address.

17. The device of claim 15, wherein the first set index is derived from the set bits and the second set index is derived from the first set index.

18. The device of claim 14, wherein all of the multiple look-ups are processed if the target address meets a first criterion.

19. The device of claim 18, wherein the first criterion is that the target address maps to a boundary of the instruction block of the second cache.

20. The device of claim 18, wherein only a first of the multiple look-ups is processed if the target address does not meet the first criterion.

21. The device of claim 14, wherein the multiple look-ups comprise primary and secondary look-ups and the first cache includes a standard port to process the primary look-up and a pseudo-port to process the secondary look-up.

22. The device of claim 21, wherein the standard port comprises a tag port and a data port and the pseudo port comprises a tag port.

23. The device of claim 21, wherein the decoder drives a first index on the standard port and a second index, derived from the first index, on the pseudo port.

24. A computer system comprising:
a thread control unit to schedule execution of instructions from multiple threads;
an execution module to execute the scheduled instructions; and
a memory hierarchy to supply the execution module with instructions for the multiple threads, the memory hierarchy including:
a first cache to store instruction in multiple cache lines of a first size;
a second cache to store instructions in multiple cache lines of a second size that is different from the first size;
a main memory; and
a cache controller to generate multiple look-ups to the first cache responsive to an instruction address and to transfer a block of instructions to the first cache responsive to hit/miss signals generated by the multiple look-ups.

25. The system of claim 24, wherein the cache controller transfers a block of instructions to the first cache if a first of the multiple look-ups misses in the first cache, the block of instructions having a size equal to a portion of the cache line size of the second cache responsive to a hit/miss signal of another of the multiple look-ups.

26. The system of claim 25, further comprising a memory controller, wherein the memory controller transfers instructions from the main memory responsive to a miss in the second cache controller
